(19) United States
(12) Patent Application Publication
(10) Pub. No.: US 2019/0354935 A1
(43) Pub. Date: Nov. 21, 2019

(54) Mitigating an Effect of Bias in a Communication System

(71) Applicant: Microsoft Technology Licensing, LLC, Redmond, WA (US)

(72) Inventors: Tara HANRATTY, Sligo (IE); Terry FARRELL, Dublin (IE); Darren DOYLE, Wicklow (IE); Siobhan DUNNE, Wicklow (IE); Ashleigh Patricia CONWAY, Dublin (IE)

(21) Appl. No.: 15/982,096

(22) Filed: May 17, 2018

(51) Int. Cl. G06Q 10/10; G06N 5/04; G06Q 10/06

(52) U.S. Cl. CPC G06Q 10/1053; G06Q 10/063112; G06N 5/04

(57) ABSTRACT

A method of facilitating communication events, each between a group of users comprising a first user and other users, the method comprising: from each of a plurality of sampled communication events, determining a category of each of the other users in the respective group and determining one or more actions performed by the first user potentially indicative of bias; analysing the actions of the first user in relation to the categories of each of the other users in each respective group over the sampled communication events, in order to detect a bias of the first user that has a potential effect of impeding involvement of an identified category of user in at least part of a current or future communication event; and based on the detected bias, generating an actionable output via a user interface in order to mitigate the effect of the bias.

### BACKGROUND

It is known that human users of electronic computing systems and networks can sometimes exhibit biases against users in other categories than themselves, e.g. due to the origin or inherent nature of the other users. Such biases may often even be unconscious. To address this some providers have already developed bias detection tools.

In one known system, a word processing application is provided with built-in bias detection. The application can automatically detect biased language such as gender or racially exclusive language in a word processing document composed by an authoring user. In response, the application will then output a suggestion to the author to remove this kind of language from the document in question.

In another case, a resource management system comprises a software module for detecting bias in job descriptions to be published over the internet via the web. The module analyses multiple past job descriptions authored by a given user, in order to detect a bias associated with the user rather than just a particular individual document. The bias detection module then outputs proposed techniques for mitigating the bias, such as to avoid certain kinds of language or certain types of requirement for the candidates specified in the description.

In another aspect of this known resource management system, the bias detection module can analyse the questions posed by one or more interviewers in each of a plurality of screening interviews conducted by phone. The module analyses a plurality of past interviews in order to detect bias in the interviewer or interviewers, and can again then output suggested bias mitigation techniques for the interviewers.

### SUMMARY

The existing tools are motivated only by a desire to improve the behaviour of people toward one another per se. While this may be a laudable aim in itself, it is recognized herein that the bias of a user—which again may be unconscious—is not just a social or moral matter. Rather, bias by a user in a networked communication system may also feed into the communication system in a manner that impedes the utility of the system as a communication system.

For instance bias against a certain category of user may result in some users in that category not being included when addressing a communication event, such as when setting up a VoIP session between a selected group of users, thus resulting in an incomplete set of endpoints being addressed. In another example, bias may lead a user to tend to speak over a certain category of other user, thus resulting in interfering doubletalk. Thus the system is impeded from being exploited to its full efficacy as a communication system.

It would be desirable to provide a mechanism for removing an effect of human bias from a communication system for communicating between specified groups of users, in order to thus enable more effective operation of the system.

The known word processing application only detects bias in a given document and suggests removal of the detected language from that one particular document. Similarly, with regard to the known resource management system for analysing job descriptions, whilst this does detect a bias in a given user rather than just a particular document, it still only relates to the authoring of documents to be published generally for access by unidentified endpoints on the web. It does not deal with the kinds of biases that may exist in and hinder communication events between particular groups of users, such as VoIP sessions, IM sessions or email exchanges. It thus does nothing to address the question of how human bias feeds back into inefficient operation or exploitation of systems for communication between specified groups of users. In the other aspect of the known resource management system, which analyses phone interviewers, this does go some way toward detecting bias in communication sessions between groups of users, in this case a phone call. However, there is always an assumption that a given one of the users (the interview candidate) is the target of the potential bias. Thus the scope for detecting and mitigating for bias is much limited. The known system is only concerned with fairness toward the interview candidate, and fails to appreciate the possible effects of bias more generally on the communication session itself.

According to one aspect disclosed herein, there is provided method of facilitating communication events between a first user and other users, each respective one of said communication events involving a respective group of multiple of the other users wherein each group comprises a respective one or more remote users involved in the respective communication event via a communication system implemented over a packet-switched network, each of the respective remote users being selected for inclusion in the respective group via a user identifier of the remote user specified by one of the users of the respective communication event and uniquely identifying the remote user within the communication system. The method comprises automatically performing operations of: (A) from each of a plurality of sampled ones of said communication events, determining a category of each of the other users in the respective group and determining one or more actions performed by the first user potentially indicative of bias; (B) analysing the actions of the first user in relation to the categories of each of the other users in each respective group over the sampled communication events, in order to detect a bias of the first user that has a potential effect of impeding involvement of an identified category of user in at least part of a current or future one of said communication events; and (C) based on the detected bias, generating an actionable output via a user interface in order to mitigate said effect.

Each communication event may for example comprise: a voice or video call; an IM session; a shared document; an email or email exchange; or an electronic meeting invitation for a meeting to be conducted at least partially by voice call, video call or IM session. The method automatically analyses the possibility of bias by the first user in relation to each of multiple other users in each call, session or other such event, including at least one other user per communication event accessing the communication via a packet-switched network such as the internet. In embodiments the other users comprise multiple remote users per communication event. In some cases the other users in one, some or all of the communication events may also include one or more in-person participants, i.e. in the same environment (e.g. same room) as the first user rather than accessing the event remotely over a network. E.g. the in-person participant(s) may be using a same speaker phone or conference room videoing system as the first user.

The method automatically searches for one or more types of possible biases by the first user which may have the effect of impeding the utility of the system in conducting communication events via the network.

For instance in embodiments, in each of the sampled communication events, the respective group of other users may be selected by the first user; e.g. by the first user selecting to include them in an electronic meeting invite, or selecting to address them or reply to them in an email chain. In such embodiments, the analysis of the first user's actions may comprises at least determining which categories of user the first user has selected to include in the group, the detection of the bias comprising identifying a category of user which the first user has a greater tendency to neglect to select for inclusion in the group, thereby having the effect of impeding involvement by reducing a likelihood of inclusion of the identified category of user in the current or future communication event. The output may then comprise prompting the first user to select the identified category of user for inclusion in the current or future communication event.

In other examples, each communication event may comprises a bi-directional communication session in which each of the first user and the other users in the respective group can both transmit and receive content to be shared with one another as part of the session; for example a live (real-time) session such as a voice or video call (e.g. VoIP call) or an instant messaging (IM) session. In such cases, the detection of bias may comprise detecting a bias having the potential effect of impeding contribution of content by the identified category user into at least part of the current or future communication event. Said analysis may comprise analysing content of the sampled communication sessions, e.g. the audio or video content, or the text of the IM session or email chain.

In one such example, each communication session may comprise a voice call or a video call with voice; and the analysis of the first user's actions may comprise detecting instances of the first user speaking over or interrupting one or more of the other users, the detection of the bias comprising identifying a category of user which the first user has a greater tendency to speak over or interrupt, thereby having the effect of impeding contribution of content by increasing the likelihood of interfering with or truncating content from the identified category of user. In this case the output may comprise prompting the first user to refrain from speaking over or interrupting the identified category of user in the current or future communication event.

In another example, the analysis of the first user's actions may comprise applying a facial recognition algorithm to detect a facial expression or gaze of the first user in the video of the call. In this case the detection of the bias may comprise identifying a category of user towards which the first user has a greater tendency to (respectively) make negative facial expressions or fail to make eye contact, thereby having the effect of impeding contribution of content by discouraging contribution by the identified category of user. The output may comprises prompting the first user to (respectively) make more positive facial expressions or make greater eye contact toward the identified category of user.

In yet further examples, the detected bias may comprise a bias against the category of remote user. For instance, when the session is scheduled and set up by the first user, the detection of the first user's biased actions may comprise detecting that the first user has, in the past, failed to allow enough time to complete the set-up of the call before the scheduled part of the meeting, thus meaning the remote users are excluded from the opening part of the meeting. In this case the output may automatically prompt the first user to begin setting up the call in advance of the scheduled start time. In embodiments the method may comprise automatically detecting from the past communication events a representative time taken to set up a call (e.g. average time such as the mean), and the output may prompting the first user to begin setting up the call at least this much time in advance.

In another example, the detection of the first user's biased actions against the remote users may comprise detecting that the first user has, in the past, failed to take into account the time zone of the remote users when scheduling sessions, thus resulting in one or more of the remote users not being involved in some or all of the session. To address this the method may comprise automatically detecting the time zones of the remote participants and the output may prompt the first user to select a time for the session that is consistent with predetermined working hours of the remote users in their respective locations.

These and other examples are set out in more detail later.

In general the first user may or may not be the user who selected who else to include (e.g. the user who sent the meeting invite or set up the call). In some cases two or more users one of whom may be the first user) may have the ability to select which users to include (e.g. joint organizer rights for a session). In some cases, the users included in some of the communication events may be selected by the first user, and the users included in others of the communication events may be selected by someone else. The scope of the disclosure is not limited in this respect.

The output may specify one or more ways to modify the manner in which the first user conducts future communication events. Alternatively or additionally, the output may comprise a quantified measure of the first user's bias based on a number of detected instances of one of the indicative actions. The output may comprise building up a profile of the first user comprising quantified measures of two or more detected biases of the first user based on instances of a respective two or more types of indicative action detected from past communication events. The output may be provided to the first user and/or to another one or more people in a team or organization or the first user, e.g. to a supervisor of the first user. In some embodiments, the output may comprise a statistical analysis of a plurality of such first users in the same team or organization.

The sampled communication events may comprise a plurality of past communication events. In embodiments, the method may comprise tracking a change and the first user's bias over the plurality of past communication events, and the output may comprises an indication of whether the first user's bias has improved over time. In some cases the output may track the biases of the team or organization as a whole.

In alternative or additional embodiments, the sampled communication events may include the current communication event, and said output may be provided dynamically during the current communication event. In this case the system can react in real-time to the communications, rather than only after an event, and can provide feedback to help participants adjust their behaviour on-the-fly (whereas prior systems only process past events and give advice for future events, or propose adjustments as the author works on documents ahead of sharing them).

In some embodiments, the method may further comprise: (d) outputting one or more survey questions to each of the other users in the respective group during or after each of the past communication events; (e) receiving responses from at least some of the other users in response to the survey questions; and (f) based on the responses to the survey question, adapting a model modelling what actions of the first user are indicative of bias; wherein said analysis may be based on the model as adapted based on the responses. For instance, the model may be trained based on a machine learning algorithm, e.g. the model taking the form of a neural network. In this case the responses to the survey questions, the detected actions of the first user and the determined categories of the other users, over the plurality of past communication events, may be used as training data for use by the machine learning algorithm to train the model.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted herein.

### BRIEF DESCRIPTION OF THE DRAWINGS

To assist understanding of the present disclosure and to show how embodiments may be put into effect, reference is made, by way of example only, to the accompanying drawings in which:

FIG. 1 is a schematic illustration of a communication system,

FIG. 2 is a schematic block diagram showing further detail of a communication system,

FIG. 3 is a flow chart of a method of detecting and mitigating bias, and

FIG. 4 is a flow chart of a further method of detecting and mitigating bias.

### DETAILED DESCRIPTION OF EMBODIMENTS

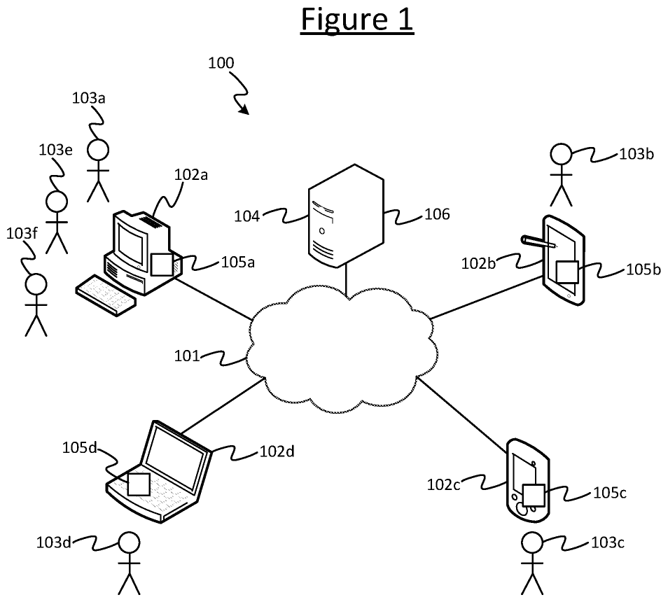

FIG. 1 illustrates an example communication system 100 implemented over a network 101 in accordance with embodiments disclosed herein. The communication system 100 comprises a plurality of user terminals 102 each associated with at least one respective user 103. Each of the user terminals 102 may take any suitable form such as a desktop computer, laptop computer, tablet, smartphone or wearable smart device (e.g. smart watch or smart glasses). Also the different user terminals 102 of the different users 103 need not necessarily all take the same form. The communication system 100 may also comprise a server 104 comprising one or more physical server units located at one or more geographic sites. Where required, distributed or “cloud” computing techniques are in themselves known in the art. Each of the user terminals 102 and the server 104 is connected to a packet-switched network 101, which may comprise for example a wide-area internetwork such as the Internet, a mobile cellular network such as a 3GPP network, a wired local area network (LAN) such as an Ethernet network, or a wireless LAN such as a Wi-Fi or 6LoWPAN network. In embodiments the network 101 may comprise a plurality of such networks, e.g. the Internet plus one or more LANs and/or cellular networks via which one or more of the user terminals 102 connect to the Internet. Each of the user terminals 102 and the server 104 may connect to the network 101 via any suitable network interface (not shown) incorporated in the respective terminal or unit, e.g. a wired modem connecting via a PSTN connection or an Ethernet connection, or a wireless modem connecting via a wireless connection such as a Wi-Fi or 6LoWPAN connection.

Each of the user terminals 102 is installed with a respective instance of a communication client application 105, e.g. a VoIP application for conducting voice or video calls, an IM application, an email client, or a collaborative workspace application providing functionality such as document sharing, an electronic whiteboard or screen sharing. In embodiments the client 105 may support multiple such communication types. Each client instance 105 is installed on storage of the respective user terminal 102 and arranged to run on a respective processing apparatus of the respective user terminal 102. The storage in which the client 105 is stored may comprise one or more memory media, e.g. magnetic medium such as a hard drive or an electronic medium such as flash memory or a solid state drive (SSD). The processing apparatus on which it is arranged to run may comprise one or more processors such as CPUs, work accelerator co-processors or application specific processors.

The server 104 is a server of a provider of the communication system (e.g. VoIP system), and is arranged to host a corresponding serving application 106. Each instance of the client 105 is installed on and arranged to run on the respective user terminal 102, and is configured so as when thus run to provide the ability to conduct communication events with the instances of the client application 105 on others of the user terminals 102. Such communication events may comprise for example: voice calls (e.g. VoIP calls), video calls (typically also including voice, e.g. VoIP), instant messaging (IM), email, document sharing, electronic whiteboard, screen sharing, or electronic meeting invitations (e.g. calendar events). Each instance of the client 105 is also configured so as when run on its respective terminal 102 to interact, via the network 101, with the serving application 106 on the server 104 in order for the serving application 106 to assist in conducting the communication events. E.g. the serving application 106 may provide for address look-up, relaying of media, presence information and/or hosting of user profiles.

In some variants, the server 104 may be replaced with the servers of two or more service providers, with respective serving applications 106 being run on each. This may be the case for example with email, where each user has his/her own respective email provider with corresponding email server. In other scenarios however all the users may use the service of the same provider, as illustrated in FIG. 1, e.g. in the case of a VoIP call or video call with VoIP, where typically all the users use a client 105 of a given provider and the same serving application 106 of that same service provider. It will be appreciated that anywhere herein where certain functionality is attributed to a server 104 of a given provider, then more generally this could be extended to the servers 104 of multiple providers operating together to provide the communication system, e.g. via a standardized or non-proprietary communication protocol.

In further alternative or additional variants, one, some or all of the user terminals 102 may use a remotely-hosted instance of the client application 105, such as a web-hosted instance (not shown), rather than an instance installed and run on the user terminal 102 itself. In this case the client instance is not run, or not entirely run, on the user terminal per se, but rather on a remote server such as the server 104 of the communication service provider. The functionality is then delivered to the respective user terminal 102 via a general purpose client application, e.g. a web browser, on the respective terminal 102. It will be appreciated that anywhere herein where functionality is attributed to an instance of a communication client 105 run or installed on a user terminal 102, this may also be extended to the variant of a remotely hosted client instance such as a web-hosted instance.

A first one of the users 103a uses a first user terminal 102a to conduct a communication event (e.g. comprising a voice or video call, IM session, email exchange, document sharing or electronic meeting invite, or a combination of these modalities) with a plurality of other users 103b-103d of other user terminals 102b-102d. That is, the first user 102a uses the respective client instance 103a on his/her respective user terminal 102a to conduct a communication event with the client instances 105b-105d on the other terminals 102b-102d via the network 101, thus enabling the communication event to be conducted amongst the respective users. Four such users 103a-103d and their respective terminals 102a-102d are shown in FIG. 1 purely for illustrative purposes, but it will be appreciated that other numbers may be involved in any given multiparty communication event. In embodiments the media content of the communication event may be relayed via the serving application 106 on the server 104. Alternatively a peer-to-peer (P2P) approach is not excluded. Either way, the serving application 106 may provide additional functionality to support the communication event, such as address look-up enabling a username or ID of each user 103a-103d to be mapped to a network address of their respective terminals 102a-102d in order to address those terminals as respective endpoints of the communication session or event.

Optionally, in some scenarios the first user 103a may be accompanied in the communication event by one or more in-person participants 103e, 103f. This may apply especially in the case of a meeting conducted partly by voice or video call, i.e. with only some remote users 103b-103d (e.g. working from home or another office location). The in-person participants 103e-f are users in the same environment as the first user 103a (e.g. same room) whom the first user can see and/or hear directly through air during the call, rather than only via the network 101. However they can still participate in the call with the other, remote users 103b-d via the network 101, by means of a shared user equipment 102a. E.g. the in-person participants 103e-f could be involved via a speakerphone or conference room video conferencing equipment shared with the first user 103a. Two such users 103f-e are shown in FIG. 1 for illustrative purposes, but it will be appreciated there could be other numbers involved in any given call, session or other such communication event. Also this is only one example scenario and in other use cases the first user terminal 102a may be used only by the first user 103a, not shared with any other participants in the same environment.

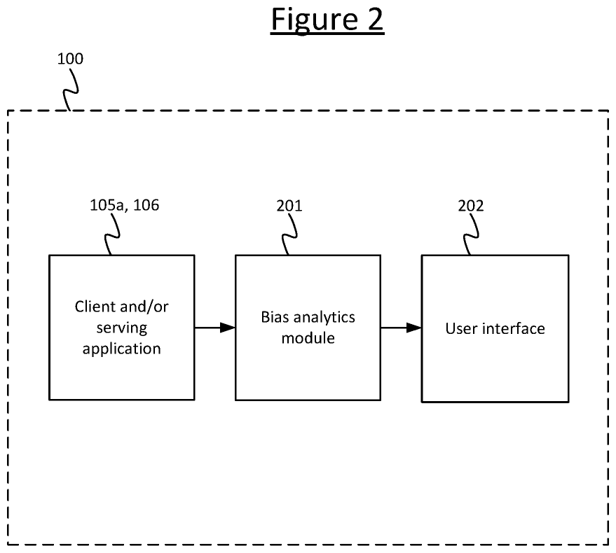

Turning to FIG. 2, the communication system comprises a bias mitigation module 201 for (at least partially) removing an effect of human bias from the operation of the communication system 100. The bias mitigation module 201 may be implemented in the form of software code embodied on computer readable storage and run on processing apparatus comprising one or more processors such as CPUs, work accelerator co-processors or application specific processors implemented on one or more computer terminals or units at one or more geographic sites. The storage on which the code is stored may comprise one or more memory devices employing one or more memory media, again implemented on one or more computer terminals or units at one or more geographic sites. Such memory media comprise for example magnetic memory such as a hard drive or electronic memory such as flash memory or a solid state drive. In embodiments the bias mitigation module 201 may be implemented on the user terminal 102a of the first user 103a, either as part of the respective client instance 105a or in a separate application interfacing to the client instance via a suitable API (application programming interface). In another example the bias mitigation module 201 may be implemented on the server 104 as part of the serving application 106, or on the server of a third-party provider (not shown). In further examples, the functionality of the bias mitigation module 201 may be split between any combination of two or more of: the first user's terminal 102a, the other users' terminals 102b-d, the server 104 of the communication provider, and/or another party's server. Again it is noted that, where required, distributed computing techniques are in themselves known in the art.

The bias mitigation module 201 is configured to detect potential bias in each of one or more sampled communication events conducted via the network and the client instances 105 of the various user terminals 102. These could be live sessions such as voice calls (e.g. VoIP calls), video calls with or without voice (e.g. VoIP), or IM messaging session. Alternatively they could be non-live events such as email chains, document sharing in an online collaborative workspace, or electronic meeting invites. In further examples, each of one or more of the sampled communication events may comprise a combination of any two or more of these modalities. In each commination session or other such event, each of the remote users 103b-103d is specifically selected to have access to the communication event. They are selected for this by specifying a user identifier such as a username uniquely identifying them within the communication system in question, e.g. within the VoIP or IM system provided by a particular provider. For instance the first user 103a enters the user identifiers (e.g. usernames) of the selected other, remote users 103b-d, and the serving application 106 performs an address look-up to resolve each selected user identifier to a respective network address of the respective user's user terminal 102 (note that as referred to herein, a user identifier means specifically an identifier of a given person, as opposed to a given piece of equipment or network endpoint). Based on the looked-up network addresses, the client instances 105 then establish the communication event specifically between the first user terminal 102a and the user terminals 102b-d of the selected remote users 103b-d. The content of the communication may then be relayed via the serving application 106 on the server 104, or may be routed directly between client instances 105 in a peer-to-peer fashion. In embodiments the in-person participants 103e-f need not be specifically selected, though in some scenarios they still are, e.g. in the case of a meeting invite being circulated to invited participants prior to a session such as a voice or video call.

Note also that the different sampled communication events need not necessarily be between the same group of selected users 103a-f, though each involves the first user 103a. In some example scenarios at least one of the other users 103b-f is common to each of some or all of the sampled communication events. In some particular example scenarios at least one of the remote 103b-d is common to each of some or all of the sampled communication events. However this is not necessary in all possible scenarios.

For each sampled communication event, the bias mitigation module 201 receives inputs from the client application 105a and/or serving application 106 indicative of one or more actions conducted by the first user 103 as part of the respective communication event. This may comprise, for example, who the first user selects to include in the communication event (see above), and/or the content of the communication event (e.g. speech content of a call recognized by a speech recognition algorithm, or the text of an IM session or email exchange). Based on this or other such information, for each communication event, the bias mitigation module 201 analyses the conduct of the first user 103a in relation to each of a group of some or all of the other users 103b-f included in the communication event, in order to detect whether or not the first user exhibits a bias in relation to any of the users in the respective group. The group of users in relation to which the first user's actions are analysed comprises some or all (i.e. plural) of the users in a given communication event, including at least one remote user and in embodiments a plurality of the remote users 103b-d per communication event. Thus the bias detection module 201 anticipates that any of a plurality of other users per communication event could be the potential target of the first user's potential bias.

The bias mitigation module 201 also determines a category of each of the other users under consideration. The possible categories could comprise for example: a gender, a race, a sexual orientation, an age or age range, geographic location, or whether attending in-person or being one of the remote users. E.g. the determined category could be: man or woman; black, white, Asian, native American, etc.; or a binary categorization such as whether white or non-white, or whether a remote participant or an in-person participant. This information could be entered manually by the other users, or the bias mitigation module 201 may look up the information in profiles of the other users (e.g. stored on the server 104). As another possibility the bias detection module 201 may detect the category information automatically such as using speech or image recognition in the case of a voice or video call respectively.

Based on the determined categories and the information on the first user's one or more actions, the bias mitigation module 201 analyses the actions of the first user 103a to detect a bias of the first user 103a against one or more identified categories of other user. E.g. this could comprise a greater tendency to speak over or interrupt that category of user, or to neglect to include them in the meeting, or not being inclusive of remote users, etc. The detected category against which the bias detection module 201 detects a bias may comprise, for example, a particular race, gender, age or age range, geographic location, or a bias against remote users. The bias may be an unconscious bias in the first user 103a. The analysis may be performed only in relation to the remote users 103b-d, or in relation to both the remote users and in-person participants 103e-f.

After a category of other user is detected as a possible target of bias by the first user 103a, the bias mitigation module 201 formulates an actionable insight comprising one or more proposed steps to correct or at least mitigate the bias, and outputs this via a user interface (UI) 202. I.e. the output may comprise outputting one or more counteractions to the first user 103a to adapt the manner in which he/she conducts the current or a future communication event. The UI through which this is output may comprise a user interface on the user terminal 102a of the first user 103a, i.e. the same user terminal 102a that the first user 103a uses to conduct the communication event(s). In a variant of this, the output may be provided through a user interface 202 of another user terminal of the first user 103a (not shown), other than used to conduct the communication event(s). E.g. the first user 103a may conduct a call via his/her desktop or laptop computer while receiving one or more insights via a companion application or general-purpose application (e.g. web-browser) running on another device such as a smartphone or wearable. As another example the output could be sent to an electronic account of the first user 103a such as an email account which he/she can access from a device of his/her choosing at a time of his/her choosing.

By whatever means provided, the output may thus be provided to the first user 103a to provide him/her with actionable steps to mitigate the bias in future communications conducted over the network 101. Alternatively or additionally, the output may be provided via a UI 202 on a user terminal of another person such as a team member or supervisor of the first user 103a. In embodiments the results may be amalgamated over a team of two or more people like the first user 103a, in order to determine a bias not just in an individual first user 103a, but across the team. The output may then comprise one or more actionable steps for the team as a whole, not just the individual. In some embodiments the bias detection module 201 may track one or more changes in the bias over multiple communication events, and the output may comprise information on the tracked change(s). Thus the first user 103a, team or supervisor are provided feedback on whether the bias is improving.

The user interface 202 may for example comprise a screen and the output may be provided visually via the screen. Alternatively or additionally, the user interface 202 may comprise one or more speakers (e.g. loudspeakers or headphones) and the output may be provided audibly. In another example the output could be provided by means of a printout. The particular means of output is not limited.

The analysis may be performed over one or more communication events involving the first user 103a. Preferably it is performed over multiple communication events involving the first user 103a so as to reduce the chance that any apparently detected behaviour was just a one-off anomaly. In this case the identified category against which the first user 103a is estimated to have a bias, and the corresponding output via the UI 202, are based on the analysis of the multiple events including at least one past communication event and preferably multiple past communication events. In embodiments the analysed communication events may include a current (presently ongoing) communication session, e.g. call or IM session, and the analysis by the bias detection module 201 and the output via the UI 202 may be performed dynamically during the session. Thus the first user 103a can be live notified during the session (preferably in a manner that only he/she can see), e.g. letting the first user 103a know that he/she is tending to interrupt remote participants, and thereby enabling the first user 103a to adapt his/her behaviour in real-time.

Thus the bias mitigation module 201 is able to take various sorts of inputs and use these to create informed insights around the types of biases from members of various groups.

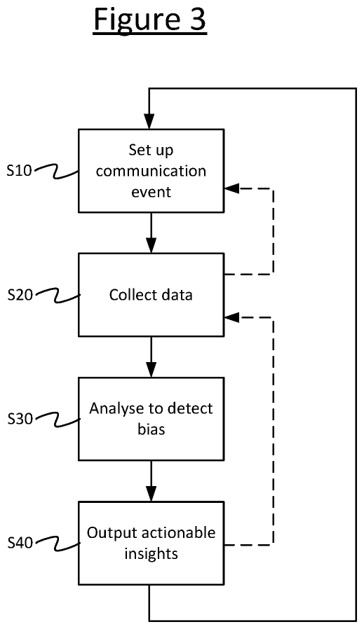

FIG. 3 illustrates the method by which data around a user's biases are collected, analysed and turned into actionable insights for that person and/or their wider team or organisation.

The method begins at step S10 with the set-up of a communication event. This may be set-up by the first user 103a or one of the other users 103b-f. In embodiments this step may comprise at least one of the users 103 of the communication event (e.g. the first user 103a) selecting through his/her respective client instance 105 which other users to include in the communication event, by selecting their user identifiers identifying them within the communication system (e.g. their usernames). The user identifiers may then be used to resolve to respective network addresses of the respective terminals 102 as discussed previously. The set-up may for example comprise the selecting user (e.g. first user 103a) selecting which usernames of a VoIP system to include in voice or video call, which usernames of an IM system to include in an IM group, which email addresses to include in an email or to reply to in an email chain, or which users to include in an electronic meeting invite (e.g. calendar event). The set-up may also comprise one or more further steps, such as the users dialing in, setting up audio and/or video equipment, setting audio or video settings, positioning a webcam or microphone, muting or unmuting themselves or others, etc.

The method then comprises three phases performed automatically by the bias detection module 201: a data collection phase S20, an analysis phase S30 and an insights phase S40. Preferably these three phases S20, S30, S40 are performed cyclically such that the system continues to learn and better mitigate biased behaviours that cause negative outcomes in the operation of the communication system 100.

In the data collection phase S20, the bias detection module 201 may pull from inputs such as: a documents the first user 103a writes, speech from meetings he/she is in, facial recognition and emotion analysis, the meetings he/she creates, communications he/she replies to (e.g. email or IM), participants included in email threads, people working on related documents (using collaborative tools), and/or user profiles.

In the analysis phase S30, the bias analysis combines the various inputs for the first user 103a to build up a profile for that user indicative of whether any biases were detected and if so what biases. In embodiments it may be expanded up to an enterprise level or department level view. It may also be able to pivot based on the people the first user 103a is interacting with. The bias detection module 201 analyses matters such as the following in an attempt to uncover bias: (i) are there people who work on related topics and are in common email threads that the first user 103a regularly does not include in his/her meetings, (ii) does the first user 103a often set up meetings with people who will be participating remotely at time that they will not be able to attend, (iii) does the first user 103a respond to some people's communications more than others, (iv) does the first user 103a react negatively when certain people talk, (v) does the first user interrupt or talk over certain other users, (vi) does the first user 103a make fail to eye contact with certain other users, (vii) does the first user 103a give short or delayed replies to some other users, and/or (viii) does the first user tend to type while others are talking? The purpose of such analysis points is to be able to detect patterns for flagging. These patterns may indicate a person's bias regarding gender, ethnicity, work style, or other.

In the insights phase the bias mitigation module 201 outputs a report on any detected biases of the first user 103a, via the user interface 202. Once a pattern has been identified, the bias mitigation module 201 can determine the likelihood of a bias based on that pattern. This can lead to several potential outcomes, including informing the first user 103a about their potential bias, recommending actions they should take, and/or prompting for other actions to be taken. This may comprise informing the first user 103a user of his her bias, and/or outputting to a wider group or supervisor. The output may for example comprise: (a) sending the first user 103a an email summary of the bias detected and how it was detected (e.g. email response rate vs reaction to certain people vs types of language used), (b) incorporating the detected bias information into an analytics tool which allows the tracking of the prominence of these patterns over time to detect whether the first user 103a is addressing his/her biases or whether they are getting worse, (c) rolling these data points up to provide team and organisation-wide insights, (d) an email can be sent out to the manager and/or members of a particular organization where a particular bias has been identified in more than a minimum number or percentage of members, and/or (e) insights can be rolled up into organization charts and the data analysed to take into account factors such as a team's geography to help identify potential causes of the biases (cultural, time zone based, etc.). An example of the latter is where people working in a particular region often don't add people in other time zones to meetings. Once a pattern of bias behaviour has been identified, the bias detection module 201 will inform the first user 103a, team, supervisor or organization and try to improve the behaviours. There then begins again the cycle again of event set-up S10, data collection S20, analysis S30 and insights S40. The bias mitigation module 201 will preferably also ensure the action taken is appropriate to the level of bias behaviour that has been flagged to the user.

In some embodiments, the bias mitigation module 201 may take data (stage S20) from multiple communication events including one or more past communication events before performing the analysis S30 for the first time. In this case the method loops back from step S20 to step S10 one or more times before proceeding to step S20, as illustrated by the first dotted line in FIG. 3. This accounts for the fact that any one-off action could simply be an anomaly, but a recurring action over multiple events may be indicative of a trend. E.g. if the first user 103a forgets to include someone once this may just be a one-off mistake, but if he/she omits the same category of user multiple times, this may be indicative of a trend.

Alternatively or additionally, in some embodiments, the process can be a dynamic, ongoing process during a given communication session (e.g. given meeting conducted by voice or video call). In this case the method provides the output S40 for a given session during that session, then loops back to step S20 one or more times during the same session to continue analysing the first user's ongoing activity during that session. This is illustrated by the second dotted line in FIG. 3.

In further alternative or additional embodiments, the output insights S40 may track a change or changes in the detected bias(es) over one or more communication events (e.g. over multiple calls, IM sessions or email chains). This enables the user, or his/her team or supervisor, etc., to track changes in the first user's bias and thus determine whether improving, worsening or staying the same. In one embodiment the bias mitigation module 201 provides a UI feature to enable the first user, or his/her team, supervisor or organization to set a goal and track the change in the change in bias against this goal.

In embodiments, the output provided by the bias mitigation module 201 comprises a quantified measure of the first user's bias based on a number of detected instances of one or more types of actions indicative of bias. This can be implemented in a number of ways. For example, consider the case where one of the actions detected in the first user 103a is a tendency to speak over or interrupt a certain identified category of other user. The metric could be the number of times he/she was detected to have done this for a given category X of other user, or a proportion of times the first user 103a has done this for category X vs. other users not in that category or the set of other users generally. A similar metric can be provided for a tendency to omit to include users in a certain category from session set-up, meeting invites or email chains (e.g. compared to a known number of other users in that category in the team, or such like). As another example, the reported output may measure the number or proportion of times the first user 103a has ignored a certain category of user, made negative expressions towards a certain other category of user, scheduled a meeting for a time not compatible with their time zone, etc. I.e. the bias detection module 201 can detect and report the number of instance of a certain negative type of action by the first user 103a toward a certain identified category of other user, either in absolute or relative terms (e.g. as a proportion compared to the number of instances of that type of action toward users not in that category or other users generally).

In embodiments, the bias mitigation module may automatically generate a profile (e.g. in the form of a matrix of scores) which describes a particular person's bias towards various groups and tracks improvements over time. E.g. the output may comprise building up a profile of the first user comprising quantified measures of two or more detected biases of the first user based on instances of a respective two or more types of indicative action detected from past communication events. The profile is created by the automated behaviour monitoring described herein, optionally combined with direct user feedback (see below). This is unlike prior bias detection tools which are aimed at improving one particular output in a fixed point in time against a pre-determined set of rules.

In embodiments the bias mitigation module 201 may be configured to detect biases according to a rule-based model. E.g. the model may specify that a detected bias is to be declared if the first user has exhibited greater than a predetermined threshold number of instances of a certain negative type of action toward a certain identified category of other user, or greater than a predetermined threshold density of such actions per unit time, or greater than a predetermined threshold proportion compared to other users not in that category or other users generally. Alternatively the classification of bias may be performed according to a model trained using machine learning.

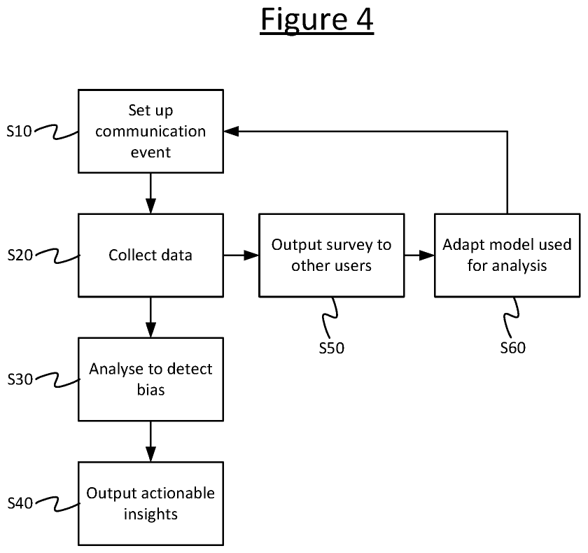

FIG. 4 illustrates an expanded method according to some embodiments disclosed herein. Here, for each of the sampled communication events, in an additional step S50 after collecting data S20, the bias mitigation module 201 outputs a survey to each of the respective group of other users 103b-f against whom possible bias is being detected. This may be transmitted to the respective user terminals 102a-d of those other users to be output via a UI of the respective terminal. It could be output through the respective client instances 105 or a companion application or general-purpose client application (e.g. web browser) on the same user terminal 102. As another example the survey could be sent to another device of the other users 103b-f, or electronic accounts of the other users such as an email account which they can access from a device of their choosing at a time of their choosing. The survey can be provided to users after the communication event in question, or may be performed live during the event (e.g. during the meeting or session). The survey comprises one or more questions asking the other users how included they felt in the communication event, e.g. asking them to give a rating from 1 to 10 (or any suitable scale), or asking them whether all the questions they raised were answered. After feedback from one or preferably multiple of the other users 103b-f, over one or preferably multiple past communication events, then the bias mitigation module 201 can use the responses to adapt the model used for bias detection. After the adaptation the updated model can then be used to detect potential bias in one or more future communication events. In embodiments the adaptation S60 may be performed incrementally with each round of feedback for each respective communication event. If the survey is provided live during the session, this can help the system to learn in real time, or to see if prompts have helped modify behaviour.

The adaptation may comprise using a rules-based approach to adapt the rules for triggering declaration of a detected bias. E.g. this may comprise noting that action P has little effect on the ratings given by other users, and therefore adapting the model to stop taking into account P or increase the threshold on the number, density or proportion of instances of action type P required to trigger a detection of bias. Or conversely the adaptation may comprise determining that action type Q has a great effect on ratings and so reducing the threshold for Q.

Alternatively the bias mitigation module 201 may comprise a machine learning algorithm arranged to perform the adaptation. In this case the model may for example comprise not a rules-based model, but a neural network. The detected actions of the first user 103a, the determined categories of the other users 103b-f, and the feedback responses to the survey, together form a training data set for adapting the model. This training data is provided to the machine learning algorithm in order to adapt the model. Over the responses from multiple other users over multiple communication events, the machine learning algorithm can gradually learn the types of behaviour that other users will find less inclusive and therefore indicate the kind of bias that will hinder their involvement in communications. In embodiments the machine learning algorithm may also be provided with a framework of actions which have the potential for indicating bias, this framework forming at least part of the model. This provides context within which to fit the training data.

Some examples of the types of bias that may be detected are now discussed in more detail.

In embodiments, in each of the sampled communication events, the respective group of other users 103b-f may be selected by the first user 103a for inclusion in the communication event. For example this may be the case where each communication event comprises a voice or video call, and also comprises a respective preceding electronic invitation (e.g. calendar event) transmitted to each of the respective group of users inviting them to attend the voice or video call. Here the selection by the first user 103a comprises the first user selecting who to include in the electronic invitation (e.g. whose username or email address to select to include in the meeting invite). In another example, each communication event may comprise an email exchange comprising an initial email and one or more reply emails. Here the selection by the first user comprises the first user selecting who to select as recipients in the initial email or who to reply to in one of the reply emails (i.e. which email addresses to include in the to, cc or bcc fields).

In such cases, bias can lead to the first user 103a omitting other users from a communication, either by not inviting them to the call not including them in emails or email replies. This can have the effect of impeding involvement by reducing a likelihood of inclusion of the identified category of user in the current or future communication event, thus resulting in the communication being routed to an incomplete set of endpoints. To address this, the analysis of the first user's actions may comprise at least determining which categories of user the first user has selected to include in the group, the detection of the bias comprising identifying a category of user which the first user has a greater tendency to neglect to select for inclusion in the group. The output may then comprises prompting the first user to select the identified category of user for inclusion in the current or future communication event.

In other example embodiments, each communication session comprises a voice call or a video call with voice. In such cases a bias may mean the first user 103a talks over or interrupts another category of user, thereby having the effect of impeding contribution by other users in that category by interfering with or truncating speech content they are attempting to contribute. An example of this is users in the category of remote user 103b-d tend to get interrupted or spoken over more than participants in person 102e-f. To address this, in embodiments the analysis of the first user's actions may comprise detecting instances of the first user 103a speaking over or interrupting one or more of the other users 103b-f. This can be implemented using a suitable speech recognition algorithm with capability of separating the voices of different users 103a-f in an audio conference or multiparty call (such an algorithm in itself being known in the art). The detection of the bias then comprising identifying a category of user which the first user has a greater tendency to speak over or interrupt. The output may then comprises prompting the first user 103a to refrain from speaking over or interrupting the identified category of user in the current or future communication event.

In further examples, the detection of the bias may comprises identifying a category of other user 103b-f to which the first user 103a has a greater tendency to give shorter responses, delay in responding, ignore, be negative towards, or be impolite towards, thereby discouraging contribution of content into the session. This can again be implemented using a speech recognition algorithm. The speech recognition algorithm identifies which portions of speech from which users are responses to which portions of speech from which other users. Based on this the bias mitigation module 201 can then detect for example when the first user is more or less positive toward certain other users 103 (“e.g. that's a good/bad idea”), or when the first user is slower in replying to some users than others, or even ignoring some category of user altogether. In such cases the output of the bias mitigation process may comprise prompting the first user 103a to be more responsive, attentive, positive or polite toward the identified category of user (respectively depending on the identified problem).

In further examples, each communication event may comprise a live session comprising a video call. In this case the analysis of the first user's actions may comprise applying a facial recognition algorithm to detect a facial expression or gaze of the first user, the detection of the bias comprising (respectively) identifying a category of user towards which the first user has a greater tendency to make negative facial expressions or fail to make eye contact. This can again have the effect of discouraging contribution of content into the session by the identified category of user. To address this, the output of the bias mitigation process may comprise prompting the first user 103a to make more positive facial expressions or make greater eye contact toward the identified category of user (respectively depending on the identified problem).

In yet further examples, each communication event is an email, and the detection of bias comprises determining that the first user has more unreplied-to emails from the identified category of other user. In this case the output may prompt the first user 103a to reply more to the emails from the identified category of user.

In embodiments, the detection of bias may comprise detecting a bias toward remote participants, e.g. they get interrupted more.

In another such example, people sometimes tend to schedule meetings only compatible with the hours of in-person participants 103e-f and not one or more other, remote users 103b-d who may be in distant time zones. Hence where each communication session comprises a voice or video call scheduled by the first user 103a in advance for a respective predetermined start time, then in embodiments, the determined category for each of the other users in the respective group comprises whether they are one of the remote users and if so a time zone in which that user is located. The determination of the first user's actions may comprise at least determining the meeting times scheduled by the first user; and the analysis comprises detecting the first user having scheduled sessions in times outside of predetermined local working hours in the time zones of remote users, thereby detecting bias against remote users in time zones different to the first user. This has the potential effect that remote users in the category of at least one different time zone cannot attend, thus defeating the point of having a VoIP meeting or the like for the benefit of users who cannot be physically present. To address this, then when the respective group for a future communication session includes at least one remote user in a time zone different to the first user, the output of the bias mitigation process may comprise prompting the first user select a start time for the future communication session that will be within the local office hours of said at least one remote user.

For instance when the first user 103a is formulating the meeting invite for a meeting with remote participants, the bias detection module 201 may automatically detect the time zones of the other participants as-and-when they are being selected by the first user 103a (e.g. by interfacing with the other user's client instances 10-5b-d or their profiles stored on the server 104). If the first user 103a also selects a meeting time that is incompatible with the known office hours of one or more of the remote users, and based on past behaviour the first user has been detected to have a tendency for bias toward remote users (such as by having one this one or more times in the past), then the bias mitigation module 201 may automatically prompt the first user 103a to remember to consider remote users. This may comprise prompting the first user to select an alternative time for the meeting currently being scheduled. It may also comprise suggesting an alternative time or times that is compatible with everyone in the selected group's time zones.

In another example of bias toward remote users, each communication session again comprises a voice or video call scheduled by the first user in advance for a respective predetermined start time. The determination of the first user's actions comprises at least determining an actual time at which the first user completes set-up of the call; and the analysis may comprise determining that the first user has not always completed set-up the call by the scheduled start time, thereby having the effect of the remote category of user missing the start of the session. For example, reasons for this could include struggling to set audio or video settings, and/or to set up audio or video equipment. To address this, the output of the bias mitigation process may comprise prompting the first user 103a to begin setting up the call in advance of the start time of the future session. In some embodiments, this may comprise identifying a representative or typical amount of time taken by the first user 103a to set up a call in the past, based on multiple of the past communication events. E.g. this could be an average time, such as the mean amount of time taken. The output to the first user 103a may then comprise reminding the user to leave at least that much time.

Note: the first user (i.e. the user for whose actions are being analysed to detect possible bias) does not necessarily have to be the initiator, host, organizer or scheduler of the communication event in all possible scenarios covered by the scope of the present disclosure. Embodiments disclosed herein can also apply where the event is set-up by one of the other users, e.g. where a call is organized by one of the other users 103b or 103e and the first user 103a (an invitee) keeps speaking over a certain category of other user. In another example, the event (e.g. being initiated by a meeting invite) may have multiple organizers who can invite participants. E.g. both the first user 103a and another user 103b can invite other participants to a VoIP session, but the first user 103a repeatedly omits to invite users in a certain category. Note also, the scope of the disclosure is not restricted to being applied only in relation to one user. For convenience the techniques herein have been described from the perspective of a first user 103a having potential bias toward other users 103b-f, but it will be appreciated that the bias mitigation module 201 (or respective instances thereof) may also operate to detect potential biases in the other users 103b-f (including in relation to the first user 103a). This may comprise operating simultaneously from all perspectives during the same communication event or during each of multiple communication events.

The scope of the presently-disclosed system is not limited by the above examples. Other examples bias that may be detected may include: (I) only presenting content in the room and not sharing it to remote participants, (II) ignoring comments from certain users in shared documents (deleting comment without reply or undoing edits by some users), (Ill) not asking everybody for feedback or input, (IV) leaving users contributions out of the meeting notes and action items, and/or (V) pushing to the next slide before people have finished talking through their points.

Some particular example use cases are now set out by way of illustration.

Joe sets up a meeting with five other participants. One of them, Fred, works from a different country in a different time zone. Because the bias analysis system hooks into Joe's email client, it helps him pick a meeting time by suggesting times that are within the working hours of all participants. Joe doesn't look to see when suits everyone and picks a random time. The system prompts him that the selected time is not inclusive towards the remote participant, as it is considerably out of their working hours and suggests another time. Joe updates the time. The system also prompts him to make the meeting enabled for VoIP.

Ten minutes before the meeting, Joe gets a notification from his email client (powered by the bias mitigation module 201) to remind him that he usually takes 8 minutes setting up a VoIP call, and that he may want to start setting up the meeting early to be respectful to everyone's time by starting the meeting on time. Joe sets up the meeting.

During the meeting, Joe and Fred are discussing a new feature. Sarah tries several times to get her point across. Because the bias mitigation module 201 hooks into the VoIP system, a notification pops up in the client UI to say that some people are not being listened to, reminding everyone of the importance of giving everyone a chance to speak. Joe asks Sarah what her point was, giving her the chance to explain. As Sarah explains, Fred keeps interrupting to get his own point across. A notification pops up on Joe's screen to say that Sarah has now been interrupted five times. Joe asks Fred to stop talking and let Sarah finish.

After the meeting, everyone is sent a quick survey by mail with a small number of questions about the inclusivity of the meeting. The questions differ a bit from person to person to be most relevant for the user.

That week, Fred's analytics report informs him that he interrupted people 24 times this week. It also says that he tends to interrupt women and is less likely to respond to emails sent to him by women. It links him to an optional training on different communications styles. A month later, Fred has made no effort to address the bias that has been pointed out to him. The training becomes mandatory.

In summary, according to the various aspects discussed above, there is thus provided a method of: collecting bias-related data points across sources such as word processing tools, email, speech, etc.; analysing of these datapoints in the context of possible bias and other individuals in the group (e.g. specified by the end user); and recommending actions to take based on the analysis (and in embodiments the severity of such action based on the behaviour itself).

In embodiments, some features can be enabled pre-meeting. E.g. the bias mitigation module 201 may notify the first user 103a in advance that remote participants have accepted the call if the first user 103a often does not remember to dial into the VoIP system. It may also remind the first user that he/she will require extra time to set up the call. As another example the bias mitigation module 201 may provide the first user 103a with tips to remember based on previous meetings and his/her own detected biases to make him/her aware of how to make a call more inclusive. As another example the bias mitigation module 201 may remind meeting participants of non-inclusive phrases they tend to use that they may want to try to avoid.

During a meeting, in embodiments the bias mitigation module 201 may for example notify the meeting owner that people are being interrupted/not being listened to. In some embodiments it may prompt users with a survey either during or after meetings to gather explicit feedback regarding the participants views on the inclusiveness of the meeting, providing feedback to the meeting owner either after the meeting or in real time.

After the meeting, in embodiments the bias mitigation module 201 may send users surveys based on bias that may have been detected during the meeting to gather more information regarding the users' experiences. Alternatively or additionally the bias mitigation module 201 may compare a person's perceived bias over time and can provide feedback on progress.

In other example features, the bias mitigation module may remind the first user 103a about he/she has not replied to where the lack of reply may be the result of an unconscious bias. In another example, the bias mitigation module may recommend team trainings based on the most common biases found within a team.

It will be appreciated that the above embodiments have been described by way of example only. Other variants or applications may become apparent to a person skilled in the art once given the disclosure herein. The scope of the disclosure is not limited by the above-described embodiments but only by the accompanying claims.

1. A method of facilitating communication events between a first user and other users, each respective one of said communication events involving a respective group of multiple of the other users wherein each group comprises a respective one or more remote users involved in the respective communication event via a communication system implemented over a packet-switched network, each of the respective remote users being selected for inclusion in the respective group via a user identifier of the remote user specified by one of the users of the respective communication event and uniquely identifying the remote user within the communication system; the method comprising automatically performing operations of:
from each of a plurality of sampled ones of said communication events, determining a category of each of the other users in the respective group and determining one or more actions performed by the first user potentially indicative of bias;
analysing the actions of the first user in relation to the categories of each of the other users in each respective group over the sampled communication events, in order to detect a bias of the first user that has a potential effect of impeding involvement of an identified category of user in at least part of a current or future one of said communication events; and
based on the detected bias, generating an actionable output via a user interface in order to mitigate said effect.

2. The method of claim 1, wherein the plurality of sampled communication events comprise a plurality of past communication events.

3. The method of claim 1, wherein the plurality of sampled communication events include at least one past communication event and the current communication event, said output being output dynamically to the first user during the current communication event.

4. The method of claim 1, wherein the output comprises a quantified measure of the detected bias based on a number of detected instances of at least one type of the indicative actions detected from the plurality of communication events.

5. The method of claim 1, wherein:
in each of the sampled communication events, the respective group of other users is selected by the first user;
the analysis of the first user's actions comprises at least determining which categories of user the first user has selected to include in the group, the detection of the bias comprising identifying a category of user which the first user has a greater tendency to neglect to select for inclusion in the group, thereby having the potential effect of impeding involvement by reducing a likelihood of inclusion of the identified category of user in the current or future communication event; and
the output comprises prompting the first user to select the identified category of user for inclusion in the current or future communication event.

6. The method of claim 5, wherein:
each communication event comprises a voice or video call, and also a respective preceding electronic invitation transmitted to each of the respective group of users inviting them to attend the voice or video call; and
the selection by the first user comprises the first user selecting who to include in the electronic invitation.

7. The method of claim 5, wherein:
each communication event comprises an email exchange comprising an initial email and one or more reply emails; and
the selection by the first user comprises the first user selecting who to select as recipients in the initial email or who to reply to in one of the reply emails.

8. The method of claim 1, wherein:
each communication event comprises a bi-directional communication session in which each of the first user and the other users in the respective group can both transmit and receive content to be shared with the group as part of the session; and
the detection of bias comprising detecting a bias having the potential effect of impeding contribution of content by the identified category user into at least part of the current or future communication event.

9. The method of claim 8, wherein said analysis comprises analysing content of the sampled communication sessions.

10. The method of claim 9, wherein each communication session is a live session.

11. The method of claim 9, wherein:
each communication session comprises a voice call or a video call with voice;
the analysis of the first user's actions comprises detecting instances of the first user speaking over or interrupting one or more of the other users, the detection of the bias comprising identifying a category of user which the first user has a greater tendency to speak over or interrupt, thereby having the potential effect of impeding contribution of content by increasing the likelihood of interfering with or truncating content from the identified category of user; and
the output comprises prompting the first user to refrain from speaking over or interrupting the identified category of user in the current or future communication event.

12. The method of claim 9, wherein:
the analysis of the first user's actions comprises detecting one or more of the following in responses by the first user to the other users: a length of the response, a delay in responding, ignoring questions, a degree of positivity, or degree of politeness of reply;
the detection of the bias comprises, respectively, identifying a category of user to which the first user has a greater tendency to give shorter responses, delay in responding, ignore, be negative towards, or be impolite towards, thereby having the potential effect of impeding contribution of content by discouraging contribution by the identified category of user; and
the output comprises prompting the first user to, respectively, be more responsive, attentive, positive or polite toward the identified category of user.

13. The method of claim 9, wherein:
each communication session comprises a video call;
the analysis of the first user's actions comprises applying a facial recognition algorithm to detect a facial expression or gaze of the first user, the detection of the bias comprising, respectively, identifying a category of user towards which the first user has a greater tendency to make negative facial expressions or fail to make eye contact, thereby having the potential effect of impeding contribution of content by discouraging contribution by the identified category of user; and
the output comprises prompting the first user to, respectively, make more positive facial expressions or make greater eye contact toward the identified category of user.

14. The method of claim 8, wherein:
in each of the sampled communication events, the determined category for each of the other users in the respective group comprises whether the user is a participant in-person or one of the remote users;
the detection of bias comprises detecting a bias against the remote users, said identified category being the category of remote user.

15. The method of claim 14, wherein:
each communication session comprises a voice or video call scheduled by the first user in advance for a respective predetermined start time;
the determination of the first user's actions comprises at least determining an actual time at which the first user completes set-up of the call;
the analysis comprises determining that the first user has not always completed set-up the call by the scheduled start time, thereby having the potential effect of the remote category of user missing the start of the session;
the output comprises prompting the first user to begin setting up the call in advance of the start time of the future session.

16. The method of claim 14, wherein:
each communication session comprises a live session scheduled in advance by the first user for a predetermined meeting time or range of times;
in each of the analysed communication events, the determined category for each of the other users in the respective group comprises whether they are one of the remote users and if so a time zone in which that user is located;
the determination of the first user's actions comprises at least determining the meeting times scheduled by the first user;
the analysis comprises detecting the first user having scheduled sessions in times outside of predetermined local working hours in the time zones of remote users, thereby detecting bias against remote users in time zones different to the first user, having the potential effect that remote users in the category of at least one different time zone cannot attend;
the respective group for the future communication session includes at least one remote user in a time zone different to the first user; and
the output comprises prompting the first user select a start time for the future communication session that will be within the local office hours of said at least one remote user.

17. The method of claim 2, wherein the method comprises tracking a change and the first user's bias over the plurality of past communication events, and the output comprises an indication of whether the first user's bias has improved over time.

18. The method of claim 2, further comprising:
outputting one or more survey questions to each of the other users in the respective group during or after each of the past communication events;
receiving responses from at least some of the other users in response to the survey questions; and
based on the responses to the survey question, adapting a model modelling what actions of the first user are indicative of bias;
wherein said analysis is based on the model as adapted based on the responses.

19. A computer program for facilitating communication events between a first user and other users, each respective one of said communication events involving a respective group of multiple of the other users wherein each group comprises a respective one or more remote users involved in the respective communication event via a communication system implemented over a packet-switched network, each of the respective remote users being selected for inclusion in the respective group via a user identifier of the remote user specified by one of the users of the respective communication event and uniquely identifying the remote user within the communication system; the computer program being embodied on computer-readable storage and configured so as when run one or more processors to perform operations of:
from each of a plurality of sampled ones of said communication events, determining a category of each of the other users in the respective group and determining one or more actions performed by the first user potentially indicative of bias;
analysing the actions of the first user in relation to the categories of each of the other users in each respective group over the sampled communication events, in order to detect a bias of the first user that has a potential effect of impeding involvement of an identified category of user in at least part of a current or future one of said communication events; and
based on the detected bias, generating an actionable output via a user interface in order to mitigate said effect.

20. Computer apparatus for facilitating communication events between a first user and other users, each respective one of said communication events involving a respective group of multiple of the other users wherein each group comprises a respective one or more remote users involved in the respective communication event via a communication system implemented over a packet-switched network, each of the respective remote users being selected for inclusion in the respective group via a user identifier of the remote user specified by one of the users of the respective communication event and uniquely identifying the remote user within the communication system; the computer apparatus comprising memory and one or more processors, the memory storing code arranged to run on the one or more processors and configured so as when thus run to perform operations of:
from each of a plurality of sampled ones of said communication events, determining a category of each of the other users in the respective group and determining one or more actions performed by the first user potentially indicative of bias;
analysing the actions of the first user in relation to the categories of each of the other users in each respective group over the sampled communication events, in order to detect a bias of the first user that has a potential effect of impeding involvement of an identified category of user in at least part of a current or future one of said communication events; and
based on the detected bias, generating an actionable output via a user interface in order to mitigate said effect.
